(19) United States
(12) Patent Application Publication
(10) Pub. No.: US 2014/0250591 A1
(43) Pub. Date: Sep. 11, 2014

(54) LIFTING DEVICE FOR HANDICAPPED PERSON

(71) Applicant: SPORTS ART INDUSTRIAL CO., LTD., Tainan (TW)

(72) Inventor: Hai Pin KUO, Tainan (TW)

(73) Assignee: SPORTS ART INDUSTRIAL CO., LTD., Tainan (TW)

(21) Appl. No.: 13/792,506

(22) Filed: Mar. 11, 2013

(51) Int. Cl. A61G 7/10

(52) U.S. Cl. CPC A61G 7/1015
USPC 5/89.1

(57) ABSTRACT

A transporting and lifting device for handicapped person includes a seat attached to a carrier for supporting a user, a front sling coupled to the front portion of the carrier and a rear sling coupled to the rear portion of the carrier for hanging and lifting and elevating the carrier and the user. The carrier includes an anchoring device attached to front portion of the carrier for connecting to the front sling with a hanging strap, and another anchoring device attached to rear portion of the carrier for connecting to the rear sling with a back board. A retaining strap is coupled to the rear sling for engaging with the user and for stably retaining the user to the rear sling.

### BACKGROUND OF THE INVENTION

1. Field of the Invention

The present invention relates to a transporting and lifting device, and more particularly to a transporting and lifting device for handicapped person including a supporting device for solidly and stably carrying and supporting a sick or handicapped person and/or for rehabilitation purposes and for allowing the sick or handicapped person to selectively actuate or operate the transporting and lifting device by himself.

2. Description of the Prior Art

Typical transporting and lifting devices for handicapped persons comprise a fastening strap or arm sling or leg sling for selectively engaging with the sick or handicapped person and for easily transporting and lifting or moving the sick or handicapped person to any selected position or location.

For example, U.S. Pat. No. 4,221,011 to Flinchbaugh discloses one of the typical transporting and lifting devices for handicapped persons comprising an arm sling and a leg sling attached or mounted or secured or coupled to a tubular member for engaging with the arm or body portion and the leg portion of the sick or handicapped person and for carrying and supporting and lifting or moving or transporting the sick or handicapped person to any selected position or location.

However, the arm sling and the leg sling may not solidly and stably carry and support the sick or handicapped persons, and the sick or handicapped persons normally may not move or activate or exercise by themselves, such that the sick or handicapped persons may have a good chance to be dropped down through the area between the arm sling and the leg sling.

U.S. Pat. No. 5,530,976 to Horcher and U.S. Pat. No. 5,644,805 to Horcher disclose two further typical transporting and lifting devices for handicapped persons each comprising an arm sling or hose attached or mounted or secured or coupled to a lifting arm of a lifting device for engaging with the arm or body portion of the sick or handicapped person and for carrying and supporting and lifting or moving or transporting the sick or handicapped person to the selected position or location.

However, the arm sling or hose may not solidly and stably carry and support the sick or handicapped persons, and the sick or handicapped persons normally may not move or activate or exercise by themselves, such that the sick or handicapped persons may have a good chance to be dropped out of the arm sling or hose inadvertently.

It is to be noted that the perineum or perineal region and/or the hip area or portion or region and/or the inguinal area or portion or region of the sick or handicapped persons normally will be wrapped or engaged with the hanging belts or fastening straps and will feel hurt after use.

The present invention has arisen to mitigate and/or obviate the afore-described disadvantages of the conventional transporting and lifting devices for handicapped persons.

### SUMMARY OF THE INVENTION

The primary objective of the present invention is to provide a transporting and lifting device for handicapped person including a supporting device for solidly and stably carrying and supporting a sick or handicapped person and/or for rehabilitation purposes and for allowing the sick or handicapped person to selectively actuate or operate the transporting and lifting device by himself.

In accordance with one aspect of the invention, there is provided a transporting and lifting device for handicapped person comprising a carrier including a front portion, a rear portion, and a middle portion, a seat attached to the carrier for supporting a user thereon, a first sling coupled to the front portion of the carrier, and a second sling coupled to the rear portion of the carrier, and the first sling and the second sling are provided for hanging and lifting and elevating the carrier and the user who is supported on the seat and for transporting and lifting or moving the user to the selected position or location.

The carrier includes a first anchoring device attached to front portion of the carrier for connecting to the first sling, and includes a second anchoring device attached to the rear portion of the carrier for connecting to the second sling.

The carrier includes a hanging strap coupled between the first anchoring device and the first sling. The first anchoring device includes two plates, and the hanging strap includes a bottom portion coupled to the plates of the first anchoring device with a pivot pin or the like.

The first anchoring device includes a bar attached to the front portion of the carrier and perpendicular to the carrier, and the plates are attached to or extended from the end portions of the bar and parallel to each other.

The seat includes a linking strap extended forwardly therefrom and coupled to the plates of the first anchoring device. The first sling includes two hanging belts having bottom portions coupled together to form a V-shaped structure and coupled to an upper portion of the hanging strap.

The carrier includes a back board coupled between the second anchoring device and the second sling. The second anchoring device includes two pairs of flaps, and the back board includes two connecting straps extended therefrom and coupled to the flaps of the second anchoring device with pivot pins respectively.

The second anchoring device includes a rod attached to the rear portion of the carrier and perpendicular to the carrier, and the flaps are attached to or extended from the end portions of the rod and parallel to each other. The seat includes two coupling straps extended rearwardly therefrom and coupled to the flaps of the second anchoring device.

The back board includes two connecting straps extended upwardly therefrom, and the second sling includes two hanging belts having bottom portions coupled to the connecting straps of the back board.

The second sling includes a retaining strap coupled to the hanging belts for connecting the hanging belts together and for engaging with the user and for stably retaining the user to the second sling.

A retaining device may further be provided and includes a first strap member coupled to the back board for engaging with the user and for retaining the user to the back board. The back board includes two fastening straps extended therefrom and coupled to two end portions of the first strap member.

The retaining device includes a second strap member coupled to the seat for engaging with the abdominal portion of the user and for stably retaining the user to the seat. The seat includes two fastening straps extended therefrom and coupled to two end portions of the second strap member.

The carrier includes a base member having two curved posts for forming a U-shaped structure, and the seat includes two ears extended downwardly therefrom and attached to the posts of the base member with an axle for allowing the seat to be pivoted relative to the base member and the carrier.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a transporting and lifting device for handicapped person in accordance with the present invention;

FIG. 2 is another partial perspective view of the transporting and lifting device for handicapped person;

FIG. 3 is a further partial perspective view of the transporting and lifting device for handicapped person;

FIG. 4 is an exploded view of the transporting and lifting device for handicapped person;

FIG. 5 is a partial side plan schematic view of the transporting and lifting device for handicapped person; and

FIGS. 6 and 7 are partial side plan schematic views similar to FIG. 5, illustrating the operation of the transporting and lifting device for handicapped person.

### DETAILED DESCRIPTION OF THE PREFERRED EMBODIMENT

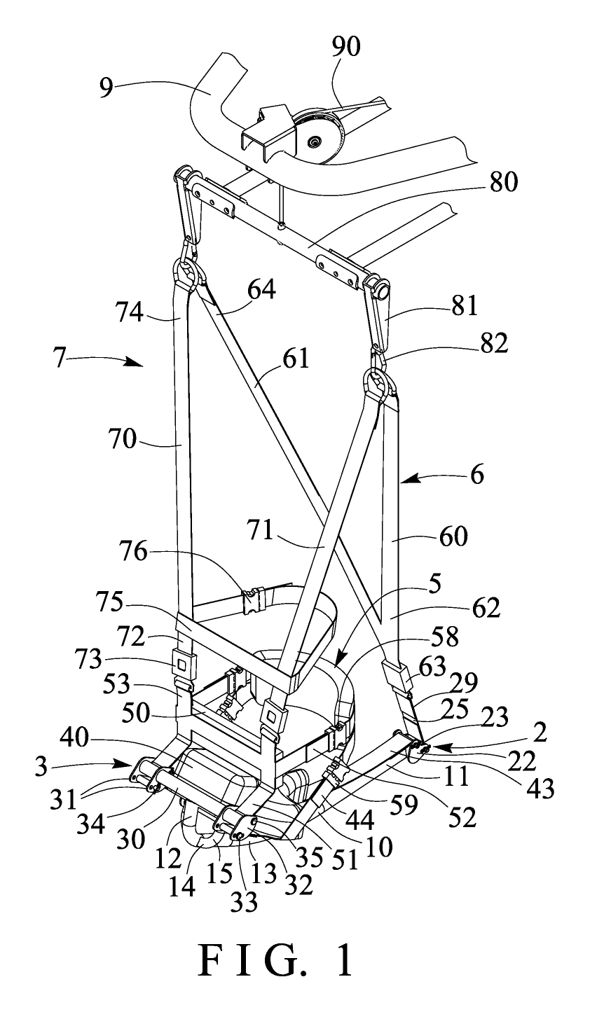

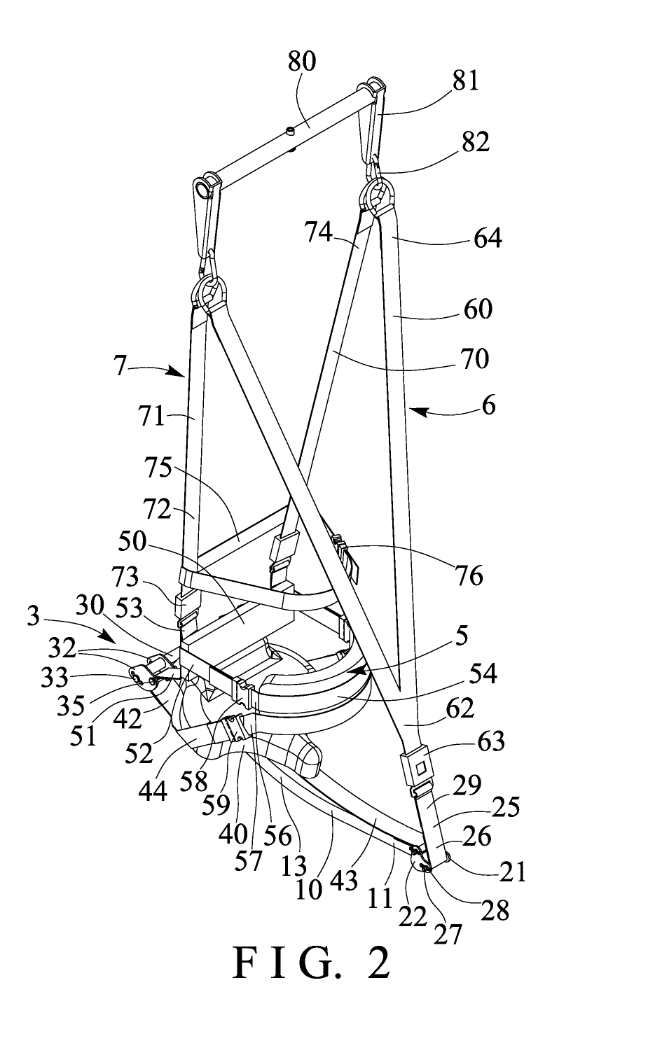

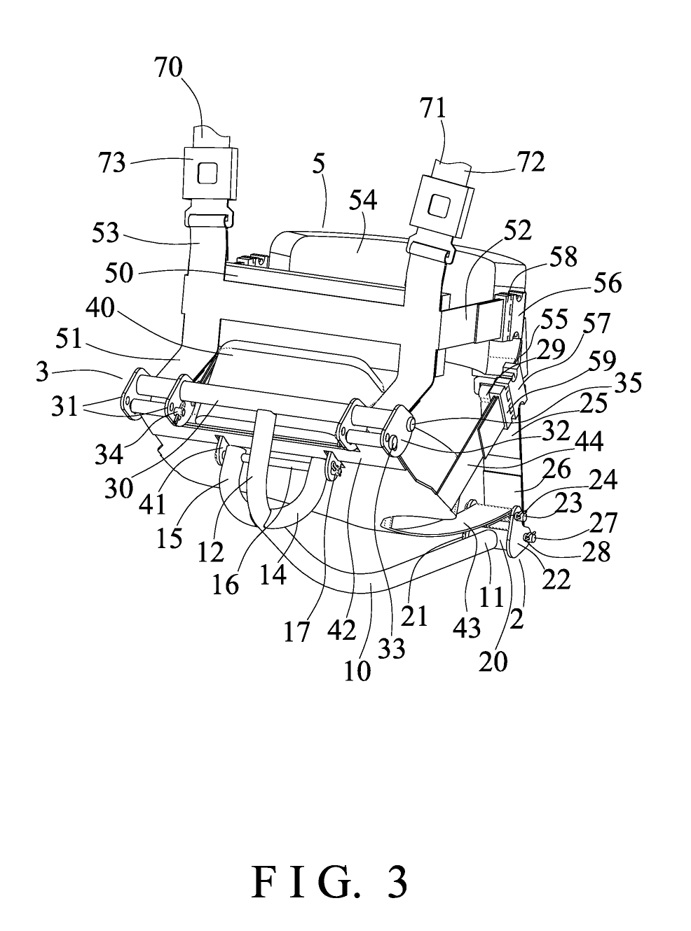

Referring to the drawings, and initially to FIGS. 1-5, a transporting and lifting device in accordance with the present invention is developed and provided for carrying and supporting and lifting or moving or transporting the sick or handicapped person to the selected position or location, and comprises a tubular or base or longitudinal member or carrier 10 including a front portion 11, a rear portion 12 and a middle or intermediate portion 13, and including a seat or base member 14 attached or mounted or secured or extended from the middle or intermediate portion 13 or the rear portion 12 of the carrier 10, and having a U-shaped structure and having two curved posts 15 for attaching or mounting or securing or supporting an axle 16 which is attached or mounted or secured or engaged through the posts 15 of the base member 14 and which may be solidly and stably secured or anchored or retained to the posts 15 of the base member 14 with lock pins 17 or the like, best shown in FIGS. 3-5.

The carrier 10 includes a front or first retaining or anchoring device 2 attached or mounted or secured to the front portion 11 of the carrier 10 and having a lateral bar 20 attached or mounted or secured to the front portion 11 of the carrier 10 and perpendicular to the carrier 10, and having one or more (such as two) boards or flaps or plates 21, 22 attached or mounted or secured to the sides or end portions of the lateral bar 20 and parallel to each other, and the carrier 10 further includes a rear or second retaining or anchoring device 3 attached or mounted or secured to the rear portion 12 of the carrier 10 and having a lateral rod 30 attached or mounted or secured to the rear portion 12 of the carrier 10 and perpendicular to the carrier 10, and having one or more (such as two) pairs of boards or plates or flaps 31, 32 attached or mounted or secured to the sides or end portions of the lateral rod 30, and the flaps 31, 32 are parallel to each other.

A seat cushion or seat 40 is attached or mounted or secured to the carrier 10, for example, the seat 40 includes one or more (such as two) boards or flaps or ears 41 extended downwardly therefrom and attached or mounted or secured or engaged with the base member 14, particularly engaged with the posts 15 of the base member 14 with the axle 16 and/or the lock pins 17 or the like for allowing the seat 40 to be pivoted or rotated relative to posts 15 of the base member 14, the seat 40 includes one or more (such as two) connecting or coupling straps 42 extended rearwardly therefrom and pivotally or rotatably attached or mounted or secured or connected or coupled to the rear or second anchoring device 3, particularly to the flaps 31, 32 of the lateral rod 30 of the rear or second anchoring device 3 with the pivot pins 33 and/or the lock pins 34 or the like for solidly and stably anchoring or retaining or securing or coupling the seat 40 to the rear portion 12 of the carrier 10.

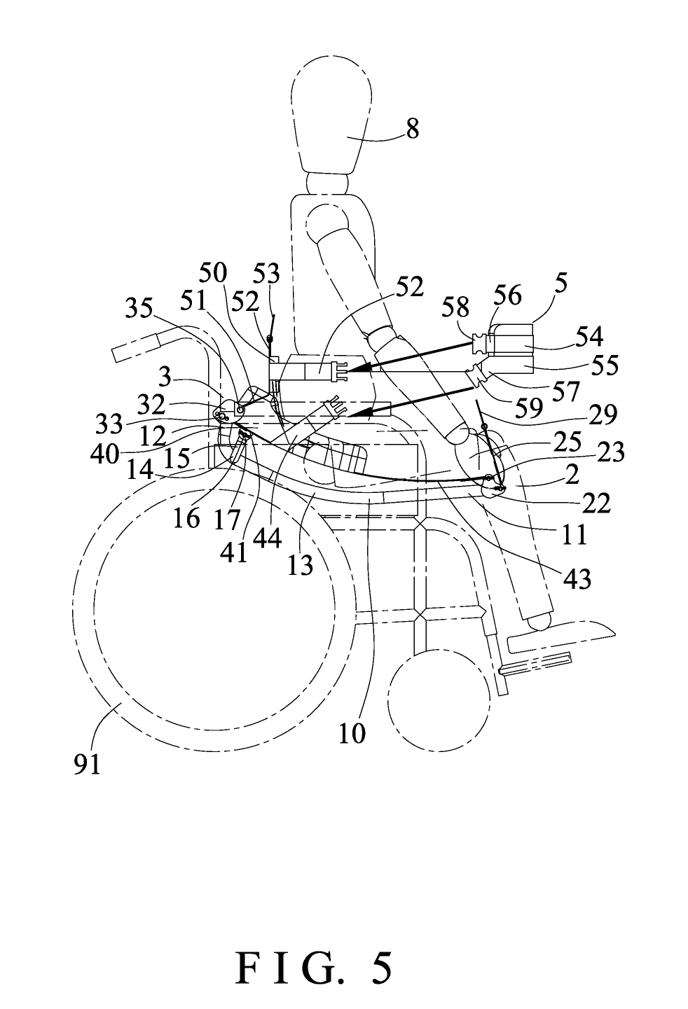

The seat 40 further includes a connecting or coupling or linking strap 43 extended forwardly therefrom and pivotally or rotatably attached or mounted or secured or connected or coupled to the front or first anchoring device 2, particularly to the plates 21, 22 of the front or first anchoring device 2 with the pivot pins 23 and/or the lock pins 24 or the like for solidly and stably anchoring or retaining or securing or coupling the seat 40 to the front portion 11 of the carrier 10. The seat 40 is provided for seating and supporting a user 8 (FIGS. 5-7) thereon, and further includes one or more (such as two) connecting or coupling or linking or fastening straps 44 extended forwardly therefrom for engaging with the user 8 and for solidly and stably anchoring or retaining or securing or coupling or locking or fastening the user 8 to the seat 40.

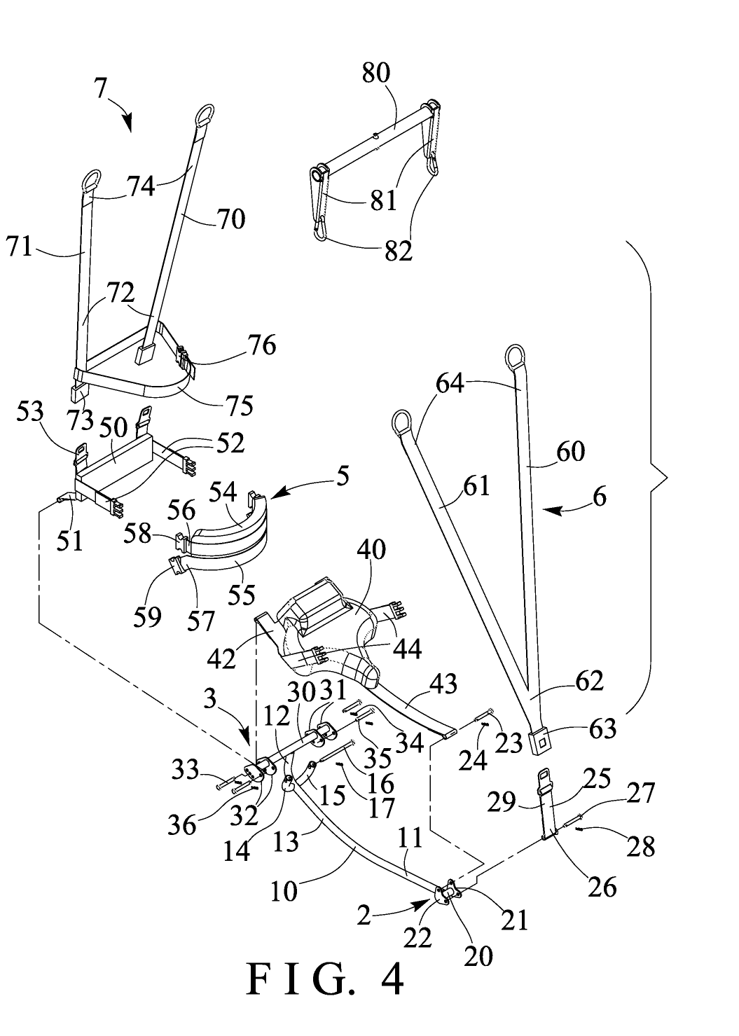

A back board 50 includes one or more (such as two) coupling or linking or fastening or connecting straps 51 extended rearwardly therefrom and pivotally or rotatably attached or mounted or secured or connected or coupled to the rear or second anchoring device 3, particularly to the flaps 31, 32 of the lateral rod 30 of the rear or second anchoring device 3 with the pivot pins 35 and/or the lock pins 36 (FIG. 4) or the like for solidly and stably anchoring or retaining or securing or coupling the back board 50 to the rear portion 12 of the carrier 10, and further includes one or more (such as two) connecting or coupling or linking or fastening straps 52 extended forwardly therefrom for engaging with the user 8 and for solidly and stably anchoring or retaining or securing or coupling or locking or fastening the user 8 to the back board 50, and further includes one or more (such as two) coupling or linking or fastening or connecting straps 53 extended upwardly therefrom.

An anchoring or securing or coupling or locking or fastening or buckle or retaining device 5 is contacted or engaged with the user 8, such as the abdominal portion of the user 8, and includes one or more (such as two) lateral straps or belts or members 54, 55 each having one or more (such as two) end portions 56, 57 attached or mounted or secured or connected or coupled or fastened to the fastening straps 52 of the back board 50 and the fastening straps 44 of the seat 40 with fastening or buckle devices 58, 59 for solidly and stably anchoring or retaining or securing or coupling or locking or fastening the user 8 to the back board 50 and the seat 40, and for preventing the user 8 from being disengaged or separated from the seat 40 and the back board 50 inadvertently. A hanging strap 25 includes a lower or bottom portion 26 pivotally or rotatably attached or mounted or secured or connected or coupled to the front or first anchoring device 2, particularly to the plates 21, 22 of the front or first anchoring device 2 with the pivot pins 27 and/or the lock pins 28 or the like, and includes an upper portion 29.

A front or first hanging device or sling 6 includes one or more (such as two) connecting or coupling or linking or fastening or hanging belts 60, 61 having the lower or bottom portions 62 secured or connected or coupled together to form a V-shaped structure or configuration and secured or connected or coupled to the front or first anchoring device 2 directly or indirectly with the hanging strap 25 and/or the fastening or buckle device 63 (FIGS. 1, 2, 4, and 6-7), and the hanging belts 60, 61 each include an upper portion 64 for connecting or coupling to a hanging rod or beam 80 with rings or loops 81 and/or snap rings 82, and for allowing the front portion 11 of the carrier 10 to be lifted or elevated with the front or first hanging device or sling 6, in which the hanging rod or beam 80 may be connected or coupled to a linking wire or cable 90 of a hanging or lifting or elevating facility 9, such as a lifting exerciser 9 or the like for allowing the hanging rod or beam 80 and the front portion 11 of the carrier 10 to be lifted or elevated with the hanging or lifting or elevating facility 9 (FIG. 1).

A rear or second hanging device or sling 7 includes one or more (such as two) connecting or coupling or linking or fastening or hanging belts 70, 71 having the lower or bottom portions 72 secured or connected or coupled to the back board 50 directly or indirectly with the connecting straps 53 and/or the fastening or buckle device 73 (FIGS. 1, 2, 4, and 6-7), and the hanging belts 70, 71 each include an upper portion 74 for connecting or coupling to the hanging rod or beam 80 with the rings or loops 81 and/or the snap rings 82, and for allowing the back board 50 and the rear portion 12 of the carrier 10 to be lifted or elevated with the rear or second hanging device or sling 7 which may also be lifted or elevated with the hanging rod or beam 80 and the hanging or lifting or elevating facility 9 (FIG. 1).

The rear or second sling 7 further includes a connecting or coupling or linking or fastening or retaining belt or strap 75 attached or mounted or secured or connected or coupled or fastened to the lower or bottom portions 72 of the hanging belts 70, 71 for connecting or coupling the lower or bottom portions 72 of the hanging belts 70, 71 together and for engaging with and securing or retaining to the user 8 with a fastening or buckle device 76 and for further solidly and stably anchoring or retaining or securing or coupling or locking or fastening the user 8, particularly the chest portion of the user 8 to the hanging belts 70, 71 of the rear or second sling 7 and the back board 50, and for further preventing the user 8 from being disengaged or separated from the seat 40 and the back board 50 and the hanging belts 70, 71 of the rear or second sling 7 inadvertently.

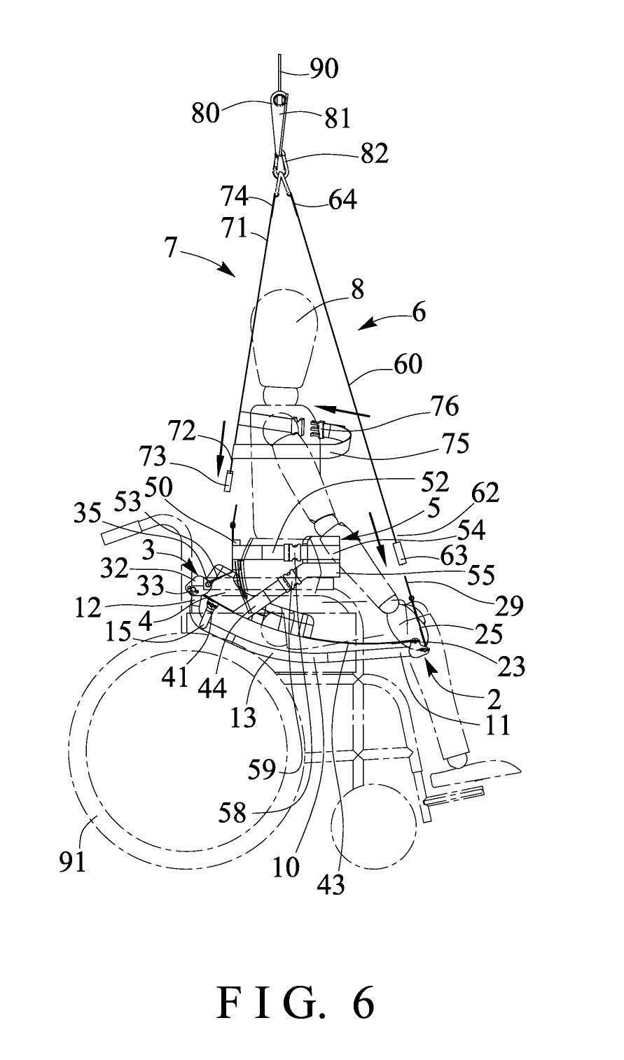

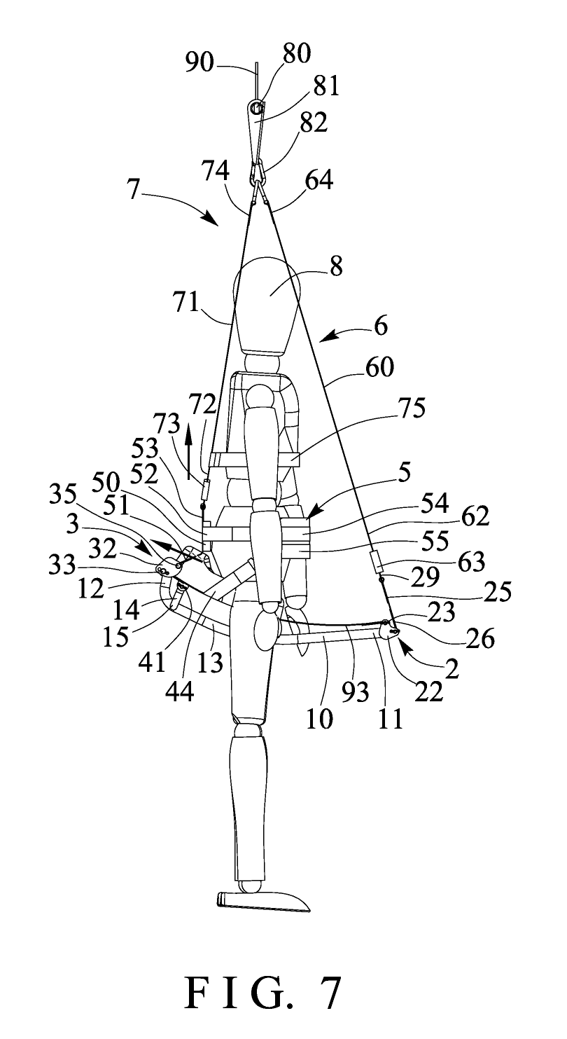

In operation, as shown in FIG. 5, the carrier 10 and the seat 40 and the back board 50 may be disposed or supported in or on a wheel chair 91 or the like for seating and supporting the user 8 thereon, and the front or first sling 6 may then be attached or mounted or secured or connected or coupled or fastened to the front portion 11 of the carrier 10 (FIG. 6) directly or indirectly with the hanging strap 25 and/or the front or first anchoring device 2 and/or the fastening or buckle device 63, and the rear or second sling 7 may then be attached or mounted or secured or connected or coupled or fastened to the rear portion 12 of the carrier 10 directly or indirectly with the connecting straps 53 of the back board 50 and/or the fastening or buckle devices 73 and/or the rear or second anchoring device 3, and the front or first sling 6 and the rear or second sling 7 may then be attached or mounted or secured or connected or coupled or fastened to the hanging rod or beam 80 which may then be connected or coupled to the linking wire or cable 90 of the hanging or lifting or elevating facility 9, such as the lifting exerciser 9 or the like for allowing the hanging rod or beam 80 and the carrier 10 to be lifted or elevated with the hanging or lifting or elevating facility 9 (FIGS. 1, 7).

The linking wire or cable 90 of the hanging or lifting or elevating facility 9 may be actuated or operated or pulled by the user 8 himself, for example, in order to lift or elevate the user 8 himself and act as a rehabilitation exercise for the user 8, particularly the sick or the handicapped person; or the linking wire or cable 90 of the hanging or lifting or elevating facility 9 may be actuated or operated or pulled by the other person in order to help lifting or elevating the user 8 and to conduct the rehabilitation exercise for the user 8, or for lifting or elevating and moving or transporting the user 8 to any selected position or location.

It is to be noted that the seat 40 is solidly and stably anchored or retained or secured or coupled to the carrier 10 with the connecting or coupling straps 42 and/or the connecting or coupling or linking strap 43 which will not be wrapped or fastened to or engaged with the perineum or perineal region and/or the hip area or portion or region and/or the inguinal area or portion or region of the sick or handicapped persons such that the sick or handicapped persons will not feel hurt after use by the hanging belts or fastening straps and the like, and the sick or handicapped persons may be comfortably seated and supported on the seat 40 without being wrapped or engaged with the hanging belts or fastening straps and the like.

Accordingly, the transporting and lifting device for handicapped person in accordance with the present invention includes a supporting device for solidly and stably carrying and supporting a sick or handicapped person and/or for rehabilitation purposes and for allowing the sick or handicapped person to selectively actuate or operate the transporting and lifting device by himself.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A transporting and lifting device for handicapped person comprising:
a carrier including a front portion, a rear portion, and a middle portion,
a seat attached to said carrier for supporting a user thereon,
a first sling coupled to said front portion of said carrier, and
a second sling coupled to said rear portion of said carrier, and
said first sling and said second sling being provided for hanging and lifting and elevating said carrier and the user who is supported on said seat.

2. The transporting and lifting device as claimed in claim 1, wherein said carrier includes a first anchoring device attached to front portion of said carrier for connecting to said first sling, and includes a second anchoring device attached to said rear portion of said carrier for connecting to said second sling.

3. The transporting and lifting device as claimed in claim 2, wherein said carrier includes a hanging strap coupled between said first anchoring device and said first sling.

4. The transporting and lifting device as claimed in claim 3, wherein said first anchoring device includes two plates, and said hanging strap includes a bottom portion coupled to said plates of said first anchoring device with a pivot pin.

5. The transporting and lifting device as claimed in claim 4, wherein said first anchoring device includes a bar attached to said front portion of said carrier and perpendicular to said carrier, and said plates are attached to end portions of said bar and parallel to each other.

6. The transporting and lifting device as claimed in claim 4, wherein said seat includes a linking strap extended forwardly therefrom and coupled to said plates of said first anchoring device.

7. The transporting and lifting device as claimed in claim 3, wherein said first sling includes two hanging belts having bottom portions coupled together to form a V-shaped structure and coupled to an upper portion of said hanging strap.

8. The transporting and lifting device as claimed in claim 2, wherein said carrier includes a back board coupled between said second anchoring device and said second sling.

9. The transporting and lifting device as claimed in claim 8, wherein said second anchoring device includes two pairs of flaps, and said back board includes two connecting straps extended therefrom and coupled to said flaps of said second anchoring device with pivot pins respectively.

10. The transporting and lifting device as claimed in claim 9, wherein said second anchoring device includes a rod attached to said rear portion of said carrier and perpendicular to said carrier, and said flaps are attached to end portions of said rod and parallel to each other.

11. The transporting and lifting device as claimed in claim 9, wherein said seat includes two coupling straps extended rearwardly therefrom and coupled to said flaps of said second anchoring device.

12. The transporting and lifting device as claimed in claim 8, wherein said back board includes two connecting straps extended upwardly therefrom, and said second sling includes two hanging belts having bottom portions coupled to said connecting straps of said back board.

13. The transporting and lifting device as claimed in claim 12, wherein said second sling includes a retaining strap coupled to said hanging belts of said second sling for connecting said hanging belts together and for engaging with the user and for retaining the user to said second sling.

14. The transporting and lifting device as claimed in claim 8, wherein a retaining device includes a first strap member coupled to said back board for engaging with the user and for retaining the user to said back board.

15. The transporting and lifting device as claimed in claim 14, wherein said back board includes two fastening straps extended therefrom and coupled to two end portions of said first strap member.

16. The transporting and lifting device as claimed in claim 14, wherein said retaining device includes a second strap member coupled to said seat for engaging with the user and for retaining the user to said seat.

17. The transporting and lifting device as claimed in claim 16, wherein said seat includes two fastening straps extended therefrom and coupled to two end portions of said second strap member.

18. The transporting and lifting device as claimed in claim 1, wherein said carrier includes a base member having two posts, and said seat includes two ears extended downwardly therefrom and attached to said posts of said base member with an axle.
